(19) United States
(12) Patent Application Publication
(10) Pub. No.: US 2019/0163380 A1
(43) Pub. Date: May 30, 2019

(54) REWRITING CHECKING DEVICE, REWRITING CHECKING METHOD, AND NON-TRANSITORY COMPUTER READABLE MEDIUM FOR REWRITING CHECKING

(71) Applicant: DENSO TEN Limited, Kobe-shi (JP)

(72) Inventors: Yumi SHIMIZU, Kobe-shi (JP); Hironori YOHATA, Kobe-shi (JP); Naoto MORI, Kobe-shi (JP); Shigeto UMEYAMA, Kobe-shi (JP); Hiroyuki MURAKAMI, Kobe-shi (JP)

(73) Assignee: DENSO TEN Limited, Kobe-shi (JP)

(21) Appl. No.: 16/131,417

(22) Filed: Sep. 14, 2018

(30) Foreign Application Priority Data
Nov. 27, 2017 (JP) 2017-226874

(51) Int. Cl. G06F 3/06

(52) U.S. Cl. CPC G06F 3/0619; G06F 8/65; G06F 3/0679; G06F 3/0643

(57) ABSTRACT

There is provided a rewriting checking device. An acquiring unit is configured to acquire a code stored in at least one area of areas immediately before and immediately after a rewrite target area in which rewrite data for rewriting data has been written, from a storage device having a plurality of areas, each of which has data including a specific first code and a specific end code. A checking unit is configured to check whether the code of the at least one area acquired by the acquiring unit is the same as the specific code of the at least one area of the areas immediately before and immediately after one area of the plurality of areas in which the rewrite data is required to be written.

### CROSS-REFERENCE TO RELATED APPLICATIONS

This application is based on and claims priority under 35 USC 119 from Japanese Patent Application No. 2017-226874 filed Nov. 27, 2017.

### BACKGROUND

The present disclosure relates to a rewriting checking device, a rewriting checking method, and a non-transitory computer readable medium for rewriting checking.

For purposes such as updating of software of a built-in product which is on the market, rewriting of some of data already written in a ROM area, i.e. partial rewriting (hereinafter, also referred to as partial reprogramming) is performed. In the case of performing partial rewriting, from a plurality of areas of the ROM area, a rewrite target area which is rewritable is designated as a data rewriting target (update target) area by designating a data rewrite range (addresses), and data in the rewrite target area is rewritten. Therefore, a time required to rewrite data in the case of performing partial rewriting is shorter than a time required to rewrite data in a case of rewriting the whole of the ROM area.

In the related art, in order to check whether data in a rewrite target area subjected to partial reprogramming is correct or not, comparison between data to be written in the whole of the ROM area and the data actually written in the ROM area, or comparison between the rewrite data for rewriting the data of the rewrite target area and the data actually written in the rewrite target area is performed by verification, sum-value checking, or the like.

Also, it has been proposed to provide a check area for writing check data in a part of a ROM area and detect abnormality of the ROM or the like by checking the check data before data rewriting (for example, Patent Literature 1).

[Patent Literature 1] JP-A-H8-241252

In the case of performing comparison between data required to be written in the whole of the ROM area and the data actually written in the whole of the ROM area in order to check whether the data in the rewrite target area subjected to partial reprogramming is correct, the time required to check becomes long.

Also, in the case of performing comparison between the data required to be written in the rewrite target area and the data actually written in the rewrite target area in order to check whether the data in the rewrite target area subjected to partial reprogramming is correct, it is impossible to detect errors attributable to misplacement of the rewrite data which is caused by erroneously designating a data rewrite range.

Further, in the case of detecting abnormality of the ROM or the like by checking the check data before data rewriting, since content of the rewrite target area subjected to partial reprogramming is not checked, it is impossible to guarantee the content of the rewrite target area subjected to partial reprogramming.

It is therefore an object of the present invention to provide a rewriting checking device, a rewriting checking method, and a rewriting checking computer program capable of checking errors attributable to misplacement of rewrite data and reducing the checking time.

### SUMMARY

According to an aspect of the present invention, there is provided a rewriting checking device including: an acquiring unit configured to acquire a code stored in at least one area of areas immediately before and immediately after a rewrite target area in which rewrite data for rewriting data has been written, from a storage device having plural areas, each of which has data including a specific first code and a specific end code; and a checking unit configured to check whether the code of the at least one area acquired by the acquiring unit is the same as the specific code of the at least one area of the areas immediately before and immediately after one area of the plural areas in which the rewrite data is required to be written.

According to an aspect of the present invention, there is provided a rewriting checking device including: an acquiring unit configured to acquire a code stored in at least one area of areas immediately before and immediately after a rewrite target area designated for writing rewrite data for rewriting data, from a storage device having plural areas, each of which has data including a specific first code and a specific end code; and a checking unit configured to check whether the code of the at least one area acquired by the acquiring unit is the same as the specific code of the at least one area of the areas immediately before and immediately after one area of the plural areas in which the rewrite data is required to be written.

In the rewriting checking device, at least one of the specific first code and the specific end code may be different from each of the plural areas of the storage device.

The rewriting checking device may further include a writing unit configured to write data items each including a specific first code and a specific end code into plural new areas configured by dividing the rewrite target area, respectively, when rewriting data of the rewrite target area.

The rewriting checking device may further include a writing unit configured to write data including a specific first code and a specific end code into a new area composed of two or more consecutive rewrite target areas, when rewriting data of the two or more consecutive rewrite target areas at the same time.

According to an aspect of the present invention, there is provided a rewriting checking method including: allowing a rewriting checking device to acquire a code stored in at least one area of areas immediately before and immediately after a rewrite target area in which rewrite data for rewriting data has been written, from a storage device having plural areas, each of which has data including a specific first code and a specific end code; and allowing the rewriting checking device to check whether the acquired code of the at least one area is the same as the specific code of the at least one area of the areas immediately before and immediately after one area of the plural areas in which the rewrite data is required to be written.

According to an aspect of the present invention, there is provided a rewriting checking method including: allowing a rewriting checking device to acquire a code stored in at least one area of areas immediately before and immediately after a rewrite target area designated for writing rewrite data for rewriting data, from a storage device having plural areas, each of which has data including a specific first code and a specific end code; and allowing the rewriting checking device to check whether the acquired code of the at least one area is the same as the specific code of the at least one area of the areas immediately before and immediately after one area of the plural areas in which the rewrite data is required to be stored.

According to an aspect of the present invention, there is provided a non-transitory computer readable medium storing a program causing a computer to execute a process for rewriting checking, the process including: acquiring a code stored in at least one area of areas immediately before and immediately after a rewrite target area in which rewrite data for rewriting data has been written, from a storage device having plural areas, each of which has data including a specific first code and a specific end code; and checking whether the acquired code of the at least one area is the same as the specific code of the at least one area of the areas immediately before and immediately after one area of the plural areas in which the rewrite data is required to be written.

According to an aspect of the present invention, there is provided a non-transitory computer readable medium storing a program causing a computer to execute a process for rewriting checking, the process including: acquiring a code stored in at least one area of areas immediately before and immediately after a rewrite target area designated for writing rewrite data for rewriting data, from a storage device having plural areas, each of which has data including a specific first code and a specific end code; and checking whether the acquired code of the at least one area is the same as the specific code of the at least one area of the areas immediately before and immediately after one area of the plural areas in which the rewrite data is required to be stored.

According to the present disclosure, it becomes possible to check errors attributable to misplacement of rewrite data and reduce the checking time.

### BRIEF DESCRIPTION OF THE DRAWINGS

Exemplary embodiment of the present invention will be described in detail based on the following figures, wherein:

FIG. 1 is a diagram illustrating a system including a rewriting checking device according to the present invention;

FIG. 2 is a diagram illustrating an example of a plurality of rewrite areas of a ROM 4 of FIG. 1;

FIG. 3 is a diagram for explaining the operation of a checking unit of FIG. 1;

FIG. 4 is a flow chart illustrating an example of a procedure for performing partial rewriting on the ROM 4 shown in FIG. 1;

FIG. 5 is a diagram for explaining a procedure for checking whether a rewrite range has been correctly designated;

FIG. 6 is a diagram illustrating an example of a rewrite area on which it failed to accurately perform partial rewriting;

FIG. 7 is a flow chart illustrating an example of a procedure for checking whether a rewrite target area has been correctly designated, after rewriting a part of data of the whole of the ROM 4 of an ECU 3 stored in a RAM of a PC 1 of FIG. 1 with rewrite data;

FIG. 8 is a diagram illustrating an example in which data including a specific first code and a specific end code is written in each of a plurality of new areas; and

FIG. 9 is a diagram illustrating an example in which data including a specific first code and a specific end code is written in a new area composed of two or more consecutive rewrite target areas.

### DETAILED DESCRIPTION

A rewriting checking device, a rewriting checking method, and a non-transitory computer readable medium for rewriting checking according to an embodiment of the present invention will be described in detail with reference to the drawings. In the present embodiment, the case where the rewriting checking device is implemented as an ECU (Engine Control Unit) will be described; however, it is also possible to implement the rewriting checking device with a device other than the ECU (for example, a personal computer (PC)). Also, in the present embodiment, the case where the rewriting checking method is performed by an ECU will be described; however, the rewriting checking method can also be performed by a device other than the ECU (for example, a PC). Further, in the present embodiment, the case where the rewriting checking computer program is implemented with a computer program stored in a ROM of the ECU will be described; however, the rewriting checking computer program can also be implemented with a computer program stored in other storage devices (for example, a ROM of a PC).

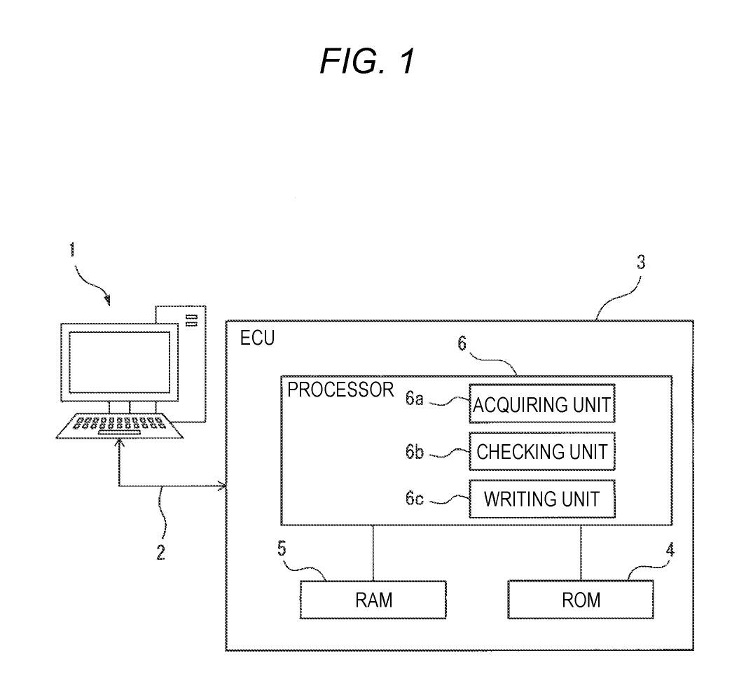

In a system shown in FIG. 1, a personal computer (PC) 1 can perform data communication with an ECU 3 through a communication channel 2. The communication channel 2 is, for example, configured by a CAN (Controller Area Network) which is connected to the ECU 3, and a communication unit which connects the CAN and the PC 1 by a USB.

The ECU 3 is an example of a computer, and includes a ROM 4 having various computer programs, a RAM 5 for temporarily storing data, and a processor 6 for executing various control computer programs. The ROM 4 is an example of a storage device.

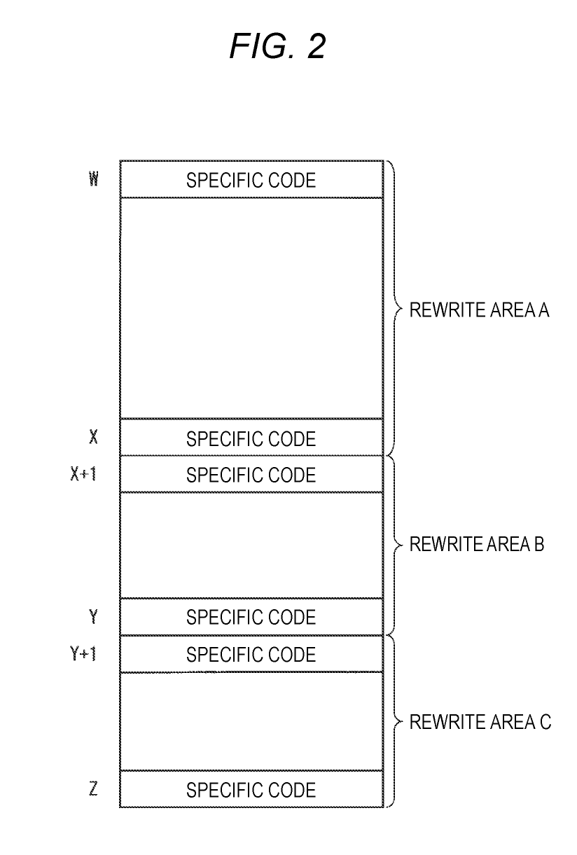

In the present embodiment, the ROM 4 has a plurality of areas, each of which has data including a specific first code and a specific end code. FIG. 2 is a diagram illustrating an example of a plurality of rewrite areas of the ROM 4 of FIG. 1. FIG. 2 shows three rewrite areas A, B, and C, each of which has data including a specific first code and a specific end code and is rewritable. In the present embodiment, an range of the rewrite area A is from an address W (W is a natural number) to an address X (X is a natural number greater than W), and an range of the rewrite area B is from an address X+1 to an address Y (Y is a natural number greater than X), and an range of the rewrite area C is from an address Y+1 to an address Z (Z is a natural number greater than Y). Also, in the present embodiment, the rewrite area B corresponds to one area of a plurality of areas in which rewrite data is required to be stored, and the rewrite area A corresponds to a previous area of the one area, and the rewrite area C corresponds to a next area of the one area. The number of rewrite areas of the ROM 4 may not be three, and the ROM may have two, or four or more rewrite areas. Also, the ROM 4 may further have one or more areas which are not rewritable, and in a case where an area which is not rewritable is the previous area of a rewrite area, data in the area which is not rewritable includes a specific end code, and in a case where an area which is not rewritable is the next area of a rewrite area, data in the area which is not rewritable includes a specific first code.

In the present embodiment, the specific first code and specific end code of the data of the rewrite area A, the specific first code and specific end code of the data of the rewrite area B, and the specific first code and specific end code of the data of the rewrite area C are all the same, for example, a specific code with a length of 4 bytes (such as 0×55AA55AA or the like).

In the present embodiment, the RAM 5 stores rewrite data for the rewrite area B, the specific end code of the data of the rewrite area A, and the specific first code of the data of the rewrite area C in association with information on the range of the rewrite area B. The PC 1 supplies the rewrite data for the rewrite area B, the specific end code of the data of the rewrite area A, the specific first code of the data of the rewrite area C, and the information on the range of the rewrite area B, acquired in advance, to the ECU 3 through the communication channel 2. Then, the processor 6 stores the rewrite data for the rewrite area B, the specific end code of the data of the rewrite area A, the specific first code of the data of the rewrite area C, and the information on the range of the rewrite area B, in the RAM 5.

In the present embodiment, the ECU includes an acquiring unit 6a, a checking unit 6b, and a writing unit 6c, which are configured as software by a program which is executed by the processor 6, or are configured as hardware by a dedicated circuit included in the processor 6.

The acquiring unit 6a acquires at least one code stored immediately before or immediately after the rewrite target area corresponding to the rewrite range designated in the information on the rewrite area range, from the ROM 4, and stores the at least one code in the RAM 5. The number of bytes of each of the at least one code acquired by the acquiring unit 6a is the same as the number of bytes of the specific first code and the number of bytes of the specific end code (for example, 4 types).

The checking unit 6b checks whether the rewrite target area has been correctly designated, by checking whether the at least one code acquired by the acquiring unit 6a is the same as any one of the specific end code of the data of the rewrite area A and the specific first code of the data of the rewrite area C.

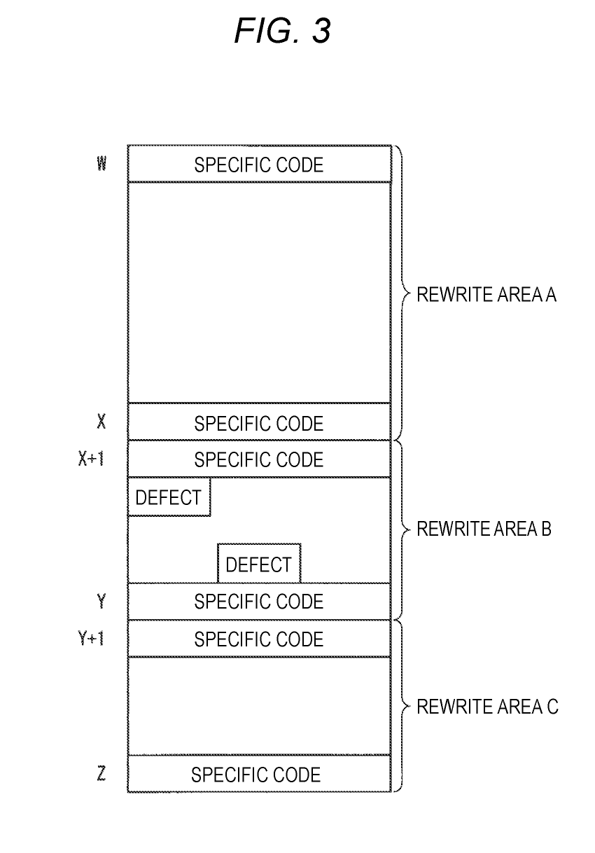

Also, in order to check whether there is a defective part in rewrite data B′ after the rewrite target area has been correctly designated and the data rewriting was finished, the checking unit 6b can also compare the rewrite data B′ and the data actually written in the rewrite area B, by verification, sum-value checking, or the like. FIG. 3 is a diagram for explaining the operation of the checking unit of FIG. 1. In a case where the rewrite area B has been properly rewritten with the rewrite data B′, but there are defective parts in the rewrite data B′ as shown in FIG. 3, since there is a defective part in the rewrite data B′, the checking unit 6b confirms that the rewriting was not normally performed.

In a case where the checking unit 6b confirms that the rewrite target area has been correctly designated, the writing unit 6c rewrites the data of the rewrite target area corresponding to the rewrite range designated in the information on the rewrite area range. For example, the writing unit 6c rewrites the data in the rewrite area B corresponding to the rewrite range designated in the information on the range of the rewrite area B, with the rewrite data B′.

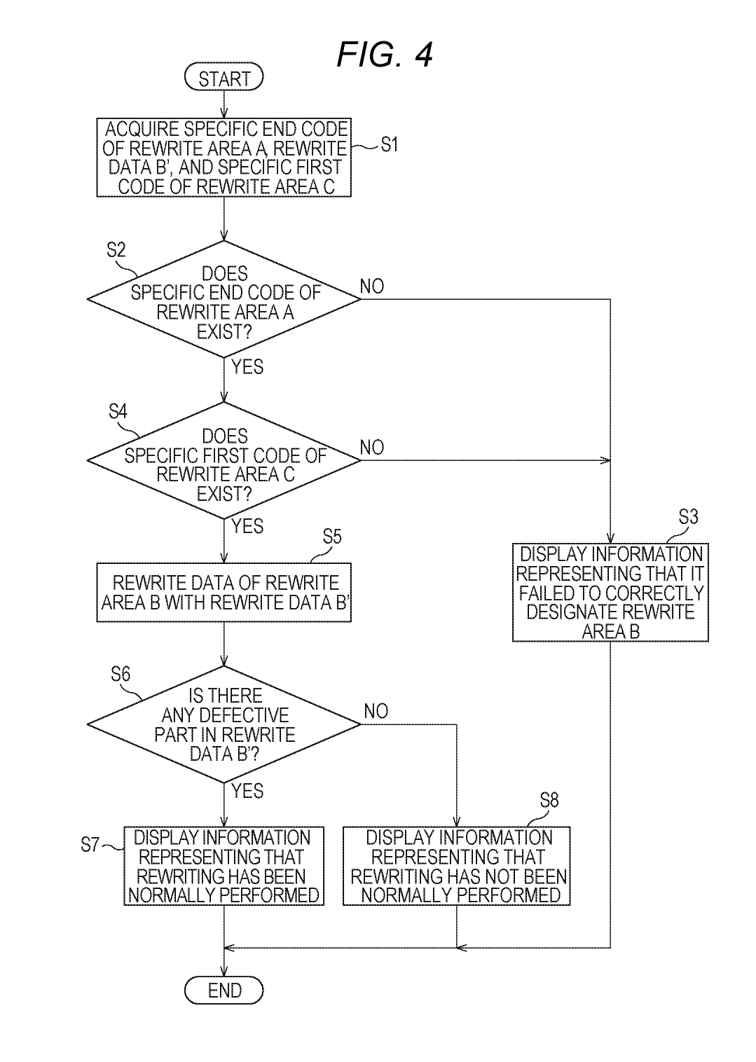

FIG. 4 is a flow chart illustrating an example of a procedure for performing partial rewriting on the ROM 4 shown in FIG. 1. This flow is for performing a process of rewriting the data of the rewrite area B of the ROM 4 with the rewrite data B′ after confirming that the rewrite target area has been correctly designated. This flow is executed mainly by the individual elements of the ECU 3, on the basis of a computer program for designated-range confirmation and partial rewriting, stored in the ROM 4 in advance. It is possible to perform processes of rewriting data of rewrite areas other than the rewrite area B by using the same flow. This flow is executed whenever the specific end code of the data of the rewrite area A, rewrite data B′, the specific first code of the data of the rewrite area C, and the information on the range of the rewrite area B are supplied from the PC 1 to the ECU 3.

First, the acquiring unit 6a acquires, from the PC 1, the specific end code of the data in the rewrite area A, rewrite data B′, the specific first code of the data in the rewrite area C, and the information on the range of the rewrite area B, and stores them in the RAM 5, and acquires both of the codes immediately before and immediately after the rewrite target area designated in the information on the range of the rewrite area B (STEP 51). Thereafter, the checking unit 6b determines whether the specific end code of the rewrite area A exists before the rewrite target area designated in the information on the range of the rewrite area B (in this case, in an area with a length of 4 bytes immediately before the rewrite target area designated in the information on the range of the rewrite area B), on the basis of whether the code stored immediately before the rewrite target area designated in the information on the range of the rewrite area B is the same as the specific end code of the rewrite area A (STEP S2). In a case where the specific end code of the rewrite area A does not exist before the rewrite target area designated in the information on the range of the rewrite area B (“No” in STEP S2), i.e. in a case where the code stored immediately before the rewrite target area designated in the information on the range of the rewrite area B is not the same as the specific end code of the rewrite area A, the checking unit 6b displays information representing that it failed to correctly designate the rewrite area B, on a display unit connected to the ECU 3 (STEP S3). Thereafter, the ECU 3 ends the process.

Meanwhile, in a case where the specific end code of the rewrite area A exists before the rewrite target area designated in the information on the range of the rewrite area B (“Yes” in STEP S2), i.e. in a case where the code stored immediately before the rewrite target area designated in the information on the range of the rewrite area B is the same as the specific end code of the rewrite area A, the checking unit 6b determines whether the specific first code of the rewrite area C exists after the rewrite target area designated in the information on the range of the rewrite area B (in this case, in an area with a length of 4 bytes immediately after the rewrite target area designated in the information on the range of the rewrite area B), on the basis of whether the code stored immediately after the rewrite target area designated in the information on the range of the rewrite area B is the same as the specific first code of the rewrite area C (STEP S4). In a case where the specific first code of the rewrite area C does not exist after the rewrite target area designated in the information on the range of the rewrite area B (“No” in STEP S4), i.e. in a case where the code stored immediately after the rewrite target area designated in the information on the range of the rewrite area B is not the same as the specific first code of the rewrite area C, the process proceeds to STEP S3.

Meanwhile, in a case where the specific first code of the rewrite area C exists after the rewrite target area designated in the information on the range of the rewrite area B (“Yes” in STEP S4), i.e. in a case where the code stored immediately after the rewrite target area designated in the information on the range of the rewrite area B is the same as the specific first code of the rewrite area C, the writing unit 6c, in order to rewrite the data in the rewrite area B with the rewritten data B′, deletes the data in the rewrite area B, and writes the rewrite data B′ in the rewrite area B (STEP S5).

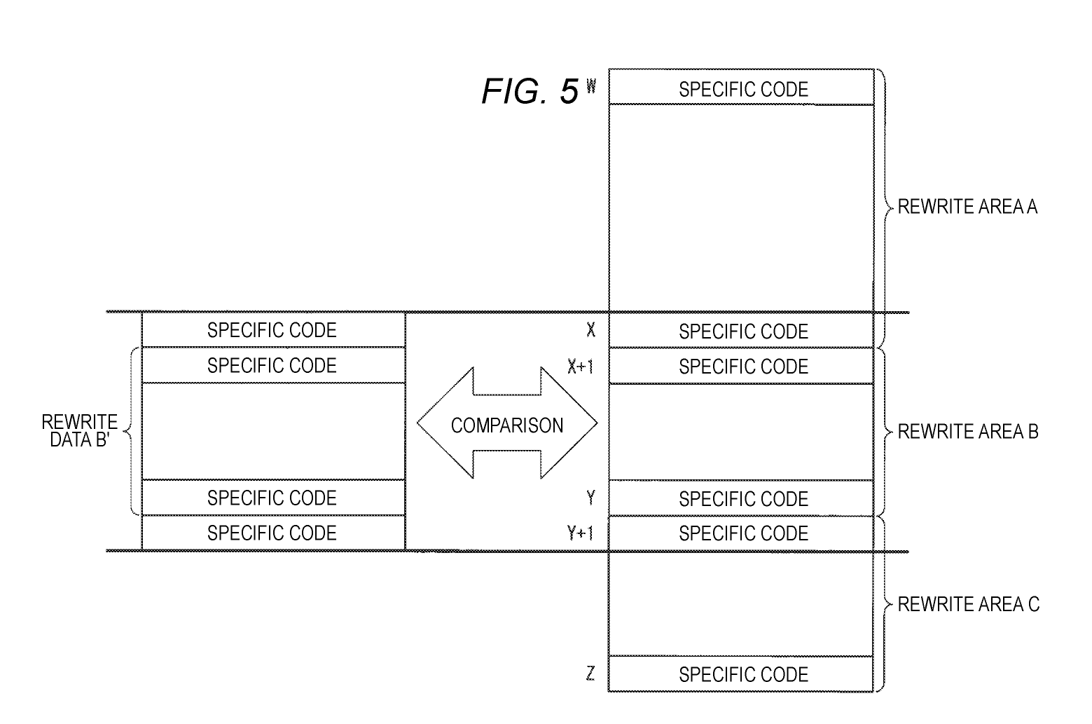

FIG. 5 is a diagram for explaining a procedure for checking whether the rewrite range has been correctly designated. In a case where the rewrite target area has been correctly designated, the range from the address X+1 to the address Y is designated as the range of the rewrite area B. Also, the code stored immediately before the rewrite target area is the same as the specific end code of the data of the rewrite area A, and the code stored immediately after the rewrite target area is the same as the specific first code of the data of the rewrite area C.

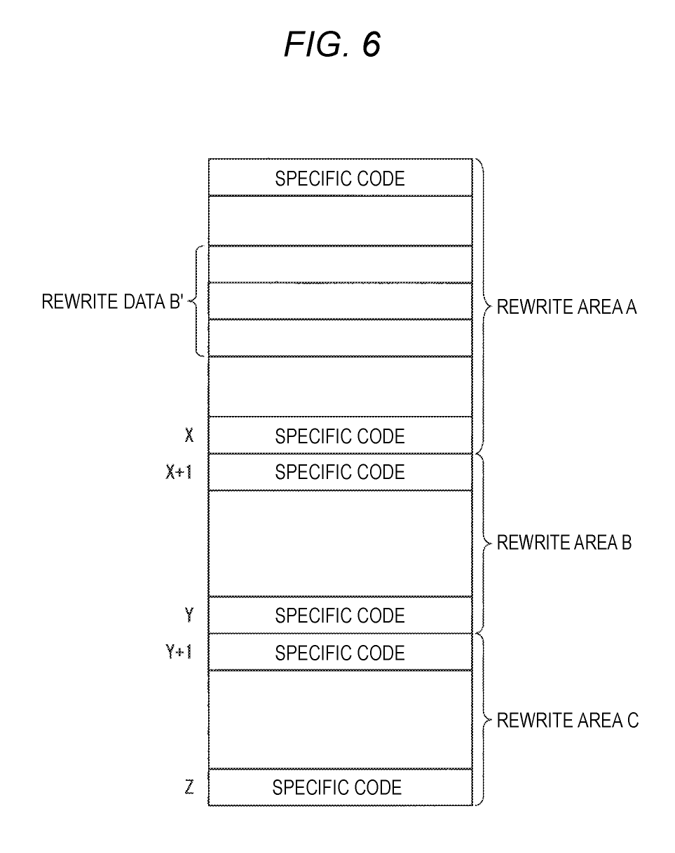

FIG. 6 is a diagram illustrating an example of the rewrite areas on which it failed to accurately perform partial rewriting. In a case where a rewrite target area is erroneously designated due to an artificial mistake, garbled data, or the like, the rewrite data B′ is not correctly written in the rewrite area B. In the example shown in FIG. 6, since the rewrite data B′ has been written in the rewrite area A, the specific codes do not exist before and after the rewrite area B′. In the present embodiment, since the checking unit checks whether the code stored immediately before the rewrite target area is the same as the specific end code of the data of the rewrite area A and whether the code stored immediately after the rewrite target area is the same as the specific first code of the data of the rewrite area C, it is possible to avoid a situation where partial rewriting is not accurately performed (misplacement of the rewrite data).

Thereafter, the checking unit 6b extracts the data written in the rewrite target area of the ROM 4 designated in the information on the range of the rewrite area B. Subsequently, in order to check whether there is a defective part in the rewrite data B′ as shown in FIG. 3, the checking unit 6b compares the extracted data and the rewrite data B′, thereby checking whether the data is the same (STEP S6). In this case, the checking unit 6b compares the data in the rewrite area B and the rewrite data B′ by verification, sum-value checking, or the like.

In a case where the data extracted from the ROM 4 by the checking unit 6b is the same as the rewrite data B′, i.e. in a case where there is no defective part in the rewrite data B′ (“No” in STEP S6), the checking unit 6b displays information representing that rewriting has been normally performed, on the display unit (not shown in the drawings) connected to the ECU 3 (STEP S7). Thereafter, the ECU 3 ends the process.

Meanwhile, in a case where the data extracted from the ROM by the checking unit 6b is not the same as the rewrite data B′, i.e. in a case where there is a defective part in the rewrite data B′ (“Yes” in STEP S6), the checking unit 6b displays information representing that rewriting was not normally performed, on the display unit connected to the ECU 3 (STEP S8). Thereafter, the ECU 3 ends the process.

In the flow chart of FIG. 4, the case where the ECU 3 checks whether the rewrite target area has been correctly designated has been described; however, the PC 1 may check whether the rewrite target area has been correctly designated, and in the case where the rewrite target area has been correctly designated, the writing unit 6c may rewrite the data of the rewrite area B of the ROM 4 with the rewrite data B′, on the basis of a command from the PC 1. In this case, the data of the whole areas of the ROM 4 before partial reprogramming is transmitted from the ECU 3 to the PC 1 through the communication channel 2, and is stored in the RAM (not shown in the drawings) of the PC 1.

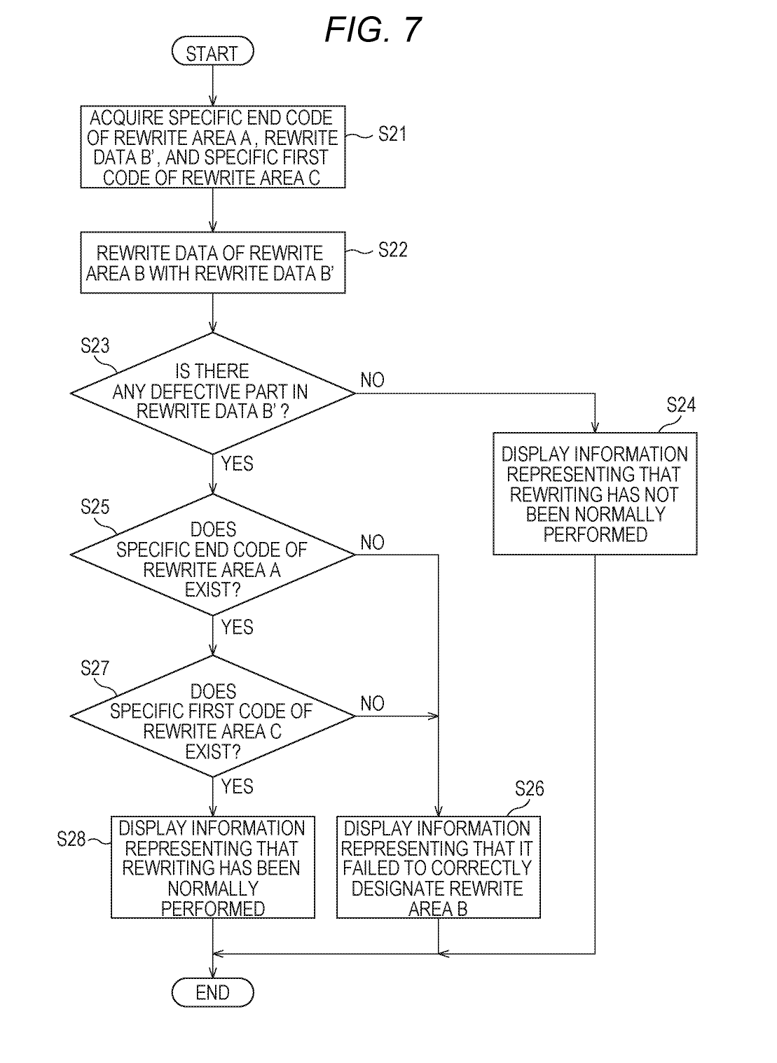

After a part of the data of the whole areas of the ROM 4 of the ECU 3 is rewritten with the rewrite data, whether the rewrite target area has been correctly designated may be checked by the PC 1 or the ECU 3. FIG. 7 is a flow chart illustrating an example of a procedure to check whether the rewrite target area has been correctly designated after a part of the data of the whole areas of the ROM 4 of the ECU 3 stored in the RAM of the PC 1 of FIG. 1 is rewritten with the rewrite data. This flow is for performing a process to check whether the rewrite target area has been correctly designated after the data which is a part of the data of the whole areas the ROM 4 stored in the RAM of the PC and corresponds to the designated rewrite range is rewritten with the rewrite data. This flow is performed mainly by the individual elements of the PC 1, on the basis of a computer program for partial rewriting and partial-rewriting content checking, stored in the ROM (not shown in the drawings) of the PC 1 in advance. It is possible to perform a process of checking whether the data in a rewrite area, other than the rewrite area B, subjected to rewriting is normal, by using the same flow. This flow is performed whenever the data of the whole areas of the ROM 4 before partial reprogramming is transmitted from the ECU 3 to the PC 1.

First, a writing unit (not shown in the drawings) of the PC 1 acquires the specific end code of the data of the rewrite area A, the rewrite data B′, the specific first code of the data of the rewrite area C, and the information on the range of the rewrite area B, from the outside (STEP S21). Thereafter, in order to rewrite the data of the rewrite target area which is a part of all data of the ROM with the rewrite data B′, the writing unit of the PC 1 deletes the data in the rewrite range, and then writes the rewrite data B′ in the rewrite range (STEP S22). Thereafter, an acquiring unit (not shown in the drawings) of the PC 1 acquires, from the RAM of the PC 1, the data which is a part of all the data of the ROM 4 corresponding to the rewrite target area designated in the information on the range of the rewrite area B, and both of the codes immediately before and immediately after the rewrite target area. Subsequently, a checking unit (not shown in the drawings) of the PC 1 compares the rewrite data B′ with the data which is a part of all data of the ROM 4 corresponding to the rewrite target area designated in the information on the range of the rewrite area B, thereby checking whether the data is the same (STEP S23). In this case, the checking unit of the PC 1 compares the data in the rewrite area B and the rewrite data B′ by verification, sum-value checking, or the like.

In a case where the data which is a part of all data of the ROM 4 corresponding to the rewrite target area designated in the information on the range of the rewrite area B is not the same as the rewrite data B′, i.e. in a case where there is a defective part in the rewrite data B′ (“Yes” in STEP S23), the checking unit of the PC 1 displays information representing that rewriting was not normally performed, on a display unit (not shown in the drawings) connected to the PC 1 (STEP S24). Thereafter, the PC 1 ends the process.

Meanwhile, in a case where the data which is a part of all data of the ROM 4 corresponding to the rewrite target area designated in the information on the range of the rewrite area B is the same as the rewrite data B′ (“No” in STEP S23), the checking unit of the PC 1 determines whether the specific end code of the rewrite area A exists before the rewrite target area designated in the information on the range of the rewrite area B (in this case, in an area with a length of 4 bytes immediately before the rewrite target area designated in the information on the range of the rewrite area B), on the basis of whether the code stored immediately before the rewrite target area designated in the information on the range of the rewrite area B is the same as the specific end code of the rewrite area A (STEP S25). In a case where the specific end code of the rewrite area A does not exist before the rewrite target area designated in the information on the range of the rewrite area B (i.e. in a case where the code stored immediately before the rewrite target area designated in the information on the range of the rewrite area B is not the same as the specific end code of the rewrite area A) (“No” in STEP S25), the checking unit of the PC 1 displays information representing that it failed to correctly designate the rewrite area B, on the display unit connected to the PC 1 (STEP S26). Thereafter, the PC 1 ends the process.

Meanwhile, in a case where the specific end code of the rewrite area A exists before the rewrite target area designated in the information on the range of the rewrite area B (i.e. in a case where the code stored immediately before the rewrite target area designated in the information on the range of the rewrite area B is the same as the specific end code of the rewrite area A) (“Yes” in STEP S25), the checking unit of the PC 1 determines whether the specific first code of the rewrite area C exists after the rewrite target area designated in the information on the range of the rewrite area B (in this case, in an area with a length of 4 bytes immediately after the rewrite target area designated in the information on the range of the rewrite area B), on the basis of whether the code stored immediately after the rewrite target area designated in the information on the range of the rewrite area B is the same as the specific first code of the rewrite area C (STEP S27). In a case where the specific first code of the rewrite area C does not exist after the rewrite target area designated in the information on the range of the rewrite area B (i.e. in a case where the code stored immediately after the rewrite target area designated in the information on the range of the rewrite area B is not the same as the specific first code of the rewrite area C) (“No” in STEP S27), the process proceeds to STEP S26.

Meanwhile, in a case where the specific first code of the rewrite area C exists after the rewrite target area designated in the information on the range of the rewrite area B (i.e. in a case where the code stored immediately after the rewrite target area designated in the information on the range of the rewrite area B is the same as the specific first code of the rewrite area C) (“Yes” in STEP S27), the checking unit of the PC 1 displays information representing that rewriting has been normally performed, on the display unit connected to the PC 1 (STEP S28). Thereafter, the PC 1 ends the process.

In the flow chart of FIG. 7, determination on whether there is a defective part in the rewrite data B′ may be performed after the determination on whether the specific end code of the rewrite area A exists and the determination on whether the specific first code of the rewrite area C exits. In other words, in the flow chart of FIG. 7, determination of STEP S25, determination of STEP S27, and determination of STEP S23 may be sequentially performed in that order.

In the flow chart of FIG. 7, the case where the data of the rewrite area B is rewritten with the rewrite data B′ by the PC 1 has been described; however, the data of the rewrite area B may be rewritten with the rewrite data B′ by the ECU 3. In this case, in order for the PC 1 to check whether the rewrite target area designated in the information on the range of the rewrite area B has been correctly designated, the data of the whole areas of the ROM 4 after partial reprogramming is transmitted from the ECU 3 to the PC 1 through the communication channel 2, and is stored in the RAM of the PC 1.

According to the present embodiment, whether the rewrite target area designated in the information on the range of the rewrite area B has been correctly designated is checked by determining whether the specific end code of the data of the rewrite area A exists before the rewrite data B′ and determining whether the specific first code of the data of the rewrite area C exists after the rewrite data B′. Therefore, it is possible to check for errors attributable to misplacement of rewrite data which is caused by erroneously designating a rewrite target area due to an artificial mistake, garbled data, or the like. Also, since confirmation of the content of the rewrite area B after rewriting of the rewrite area B is performed using the specific end code of the data of the rewrite area A, the rewrite data B′, and the specific first code of the data of the rewrite area C, it is possible to reduce the error checking time as compared to the case of confirming the contents of all data of the ROM 4. Further, it is also possible to determine whether there is a defective part in the rewrite data B′.

In the present embodiment, the case of using both of the specific end code of the data of the rewrite area A and the specific first code of the data of the rewrite area C to check whether the rewrite target area designated in the information on the range of the rewrite area B has been correctly designated has been described. However, it is also possible to use any one of the specific end code of the data of the rewrite area A and the specific first code of the data of the rewrite area C to check whether the rewrite target area designated in the information on the range of the rewrite area B has been correctly designated.

Also, in the present embodiment, the case where the specific first code and specific end code of the data of the rewrite area A, the specific first code and specific end code of the data of the rewrite area B, and the specific first code and specific end code of the data of the rewrite area C are all the same has been described. However, at least one of the specific first code and the specific end code may be set different from area to area of the ROM 4. In this case, even in the case where there are a plurality of rewrite areas having the same range, it is possible to accurately check whether the rewrite target area designated in the information on the range of the rewrite area B has been correctly designated. For example, in a case where the range of the rewrite area B and the range of the rewrite area C are the same, and the specific first codes of the rewrite area B and the rewrite area C are different, even if rewrite data C′ of the rewrite area C is erroneously written in the rewrite area B, it is possible to accurately check whether the data in the rewrite area C subjected partial reprogramming is correct, by checking the specific first code written in the rewrite area B by the checking unit of the PC 1 or the checking unit 6b of the ECU 3.

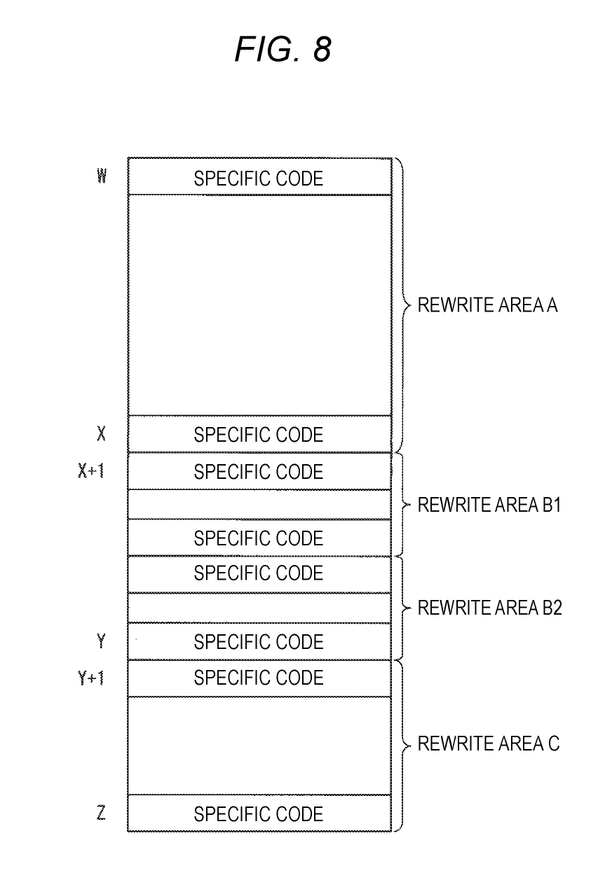

Also, when rewriting the data of the rewrite target area, the writing unit of the PC 1 or the writing unit 6c of the ECU 3 may rewrite each of a plurality of new areas configured by dividing the rewrite target area, with data including a specific first code and a specific end code. The writing unit of the PC 1 or the writing unit 6c of the ECU 3 may write data in the plurality of new areas, before checking whether the rewrite target area has been correctly designated or/and after checking whether the rewrite target area has been correctly designated. FIG. 8 is a diagram illustrating an example in which data including a specific first code and a specific end code is written in each of a plurality of new areas. For example, as shown in FIG. 8, when rewriting the rewrite area B, the writing unit of the PC 1 or the writing unit 6c of the ECU 3 may write data B1′ and B2′ including specific first codes and specific end codes respectively in a plurality of new rewrite areas B1 and B2 configured by dividing the rewrite area B. In this case, the writing unit of the PC 1 or the checking unit 6b of the ECU 3 checks whether the data item of the rewrite area B1 is correct by using the specific end data of the data of the rewrite area A, the data item B1′, and the specific first data of the data item B2′, and checks whether the data item of the rewrite area B2 is correct by using the specific end data of the data item B1′, the data item B2′, and the specific first code of the rewrite area C. Therefore, it is possible to change the range of the rewrite area subjected to partial reprogramming, and it also becomes possible to check whether the data of the rewrite area subjected to the change of rewrite area range is correct.

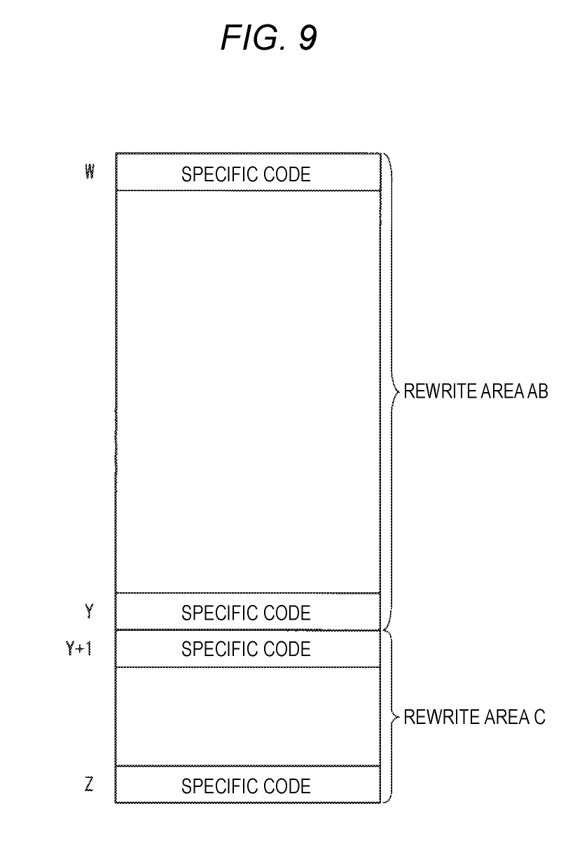

Also, when rewriting the data of two or more consecutive rewrite target areas at the same time, the writing unit of the PC 1 or the writing unit 6c of the ECU 3 may write data including a specific first code and a specific end code in a new area composed of the two or more consecutive rewrite target areas. The writing unit of the PC 1 or the writing unit 6c of the ECU 3 may write the data in the new area composed of the two or more consecutive rewrite target areas, before checking whether the rewrite target area has been correctly designated or/and after checking whether the rewrite target area has been correctly designated. FIG. 9 is a diagram illustrating an example in which data including a specific first code and a specific end code is written in a new area composed of two or more consecutive rewrite target areas. For example, as shown in FIG. 9, when rewriting the data of the consecutive rewrite areas A and B at the same time, the writing unit of the PC 1 or the writing unit 6c of the ECU 3 may write data AB including a specific first code and a specific end code in a new rewrite area AB composed of the rewrite areas A and B. In this case, the writing unit of the PC 1 or the checking unit 6b of the ECU 3 checks whether the data of the rewrite area AB is correct by using the data AB and the specific first code of the data of the rewrite area C. Therefore, it is possible to change the rewrite area range subjected to partial reprogramming, and it also becomes possible to check content of the rewrite area subjected to the change of rewrite area range.

What is claimed is:

1. A rewriting checking device comprising:
an acquiring unit configured to acquire a code stored in at least one area of areas immediately before and immediately after a rewrite target area in which rewrite data for rewriting data has been written, from a storage device having a plurality of areas, each of which has data including a specific first code and a specific end code; and
a checking unit configured to check whether the code of the at least one area acquired by the acquiring unit is the same as the specific code of the at least one area of the areas immediately before and immediately after one area of the plurality of areas in which the rewrite data is required to be written.

2. A rewriting checking device comprising:
an acquiring unit configured to acquire a code stored in at least one area of areas immediately before and immediately after a rewrite target area designated for writing rewrite data for rewriting data, from a storage device having a plurality of areas, each of which has data including a specific first code and a specific end code; and
a checking unit configured to check whether the code of the at least one area acquired by the acquiring unit is the same as the specific code of the at least one area of the areas immediately before and immediately after one area of the plurality of areas in which the rewrite data is required to be written.

3. The rewriting checking device according to claim 1, wherein:
at least one of the specific first code and the specific end code is different from each of the plurality of areas of the storage device.

4. The rewriting checking device according to claim 2, wherein:
at least one of the specific first code and the specific end code is different from each of the plurality of areas of the storage device.

5. The rewriting checking device according to claim 1, further comprising:
a writing unit configured to write data items each including a specific first code and a specific end code into a plurality of new areas configured by dividing the rewrite target area, respectively, when rewriting data of the rewrite target area.

6. The rewriting checking device according to claim 2, further comprising:
a writing unit configured to write data items each including a specific first code and a specific end code into a plurality of new areas configured by dividing the rewrite target area, respectively, when rewriting data of the rewrite target area.

7. The rewriting checking device according to claim 3, further comprising:
a writing unit configured to write data items each including a specific first code and a specific end code into a plurality of new areas configured by dividing the rewrite target area, respectively, when rewriting data of the rewrite target area.

8. The rewriting checking device according to claim 1, further comprising:
a writing unit configured to write data including a specific first code and a specific end code into a new area composed of two or more consecutive rewrite target areas, when rewriting data of the two or more consecutive rewrite target areas at the same time.

9. The rewriting checking device according to claim 2, further comprising:
a writing unit configured to write data including a specific first code and a specific end code into a new area composed of two or more consecutive rewrite target areas, when rewriting data of the two or more consecutive rewrite target areas at the same time.

10. The rewriting checking device according to claim 3, further comprising:
a writing unit configured to write data including a specific first code and a specific end code into a new area composed of two or more consecutive rewrite target areas, when rewriting data of the two or more consecutive rewrite target areas at the same time.

11. A rewriting checking method comprising:
allowing a rewriting checking device to acquire a code stored in at least one area of areas immediately before and immediately after a rewrite target area in which rewrite data for rewriting data has been written, from a storage device having a plurality of areas, each of which has data including a specific first code and a specific end code; and
allowing the rewriting checking device to check whether the acquired code of the at least one area is the same as the specific code of the at least one area of the areas immediately before and immediately after one area of the plurality of areas in which the rewrite data is required to be written.

12. A rewriting checking method comprising:
allowing a rewriting checking device to acquire a code stored in at least one area of areas immediately before and immediately after a rewrite target area designated for writing rewrite data for rewriting data, from a storage device having a plurality of areas, each of which has data including a specific first code and a specific end code; and
allowing the rewriting checking device to check whether the acquired code of the at least one area is the same as the specific code of the at least one area of the areas immediately before and immediately after one area of the plurality of areas in which the rewrite data is required to be stored.

13. A non-transitory computer readable medium storing a program causing a computer to execute a process for rewriting checking, the process comprising:
acquiring a code stored in at least one area of areas immediately before and immediately after a rewrite target area in which rewrite data for rewriting data has been written, from a storage device having a plurality of areas, each of which has data including a specific first code and a specific end code; and
checking whether the acquired code of the at least one area is the same as the specific code of the at least one area of the areas immediately before and immediately after one area of the plurality of areas in which the rewrite data is required to be written.

14. A non-transitory computer readable medium storing a program causing a computer to execute a process for rewriting checking, the process comprising:
acquiring a code stored in at least one area of areas immediately before and immediately after a rewrite target area designated for writing rewrite data for rewriting data, from a storage device having a plurality of areas, each of which has data including a specific first code and a specific end code; and
checking whether the acquired code of the at least one area is the same as the specific code of the at least one area of the areas immediately before and immediately after one area of the plurality of areas in which the rewrite data is required to be stored.
